(19) United States
(12) Patent Application Publication
(10) Pub. No.: US 2018/0137215 A1
(43) Pub. Date: May 17, 2018

(54) ELECTRONIC APPARATUS FOR AND METHOD OF ARRANGING OBJECT IN SPACE

(71) Applicant: SAMSUNG ELECTRONICS CO., LTD., Suwon-si (KR)

(72) Inventors: Dong-heon LEE, Seoul (KR); Chan-woo PARK, Seongnam-si (KR); Yoo-jeong LEE, Daejeon (KR); Jang-won LEE, Suwon-si (KR); Dae-yeon JEONG, Hwaseong-si (KR)

(73) Assignee: SAMSUNG ELECTRONICS CO., LTD., Suwon-si (KR)

(21) Appl. No.: 15/815,141

(22) Filed: Nov. 16, 2017

Related U.S. Application Data
(60) Provisional application No. 62/422,675, filed on Nov. 16, 2016.

(30) Foreign Application Priority Data
Jul. 28, 2017 (KR) 10-2017-0096387

(51) Int. Cl. G06F 17/50; G06K 9/62; G06K 9/00; G06Q 30/06

(52) U.S. Cl. CPC G06F 17/5004; G06Q 30/0631; G06K 9/00671; G06K 9/6247

(57) ABSTRACT

Provided are an electronic apparatus and a method of operating the electronic apparatus. The electronic apparatus includes a processor configured to acquire space data regarding a target space, generate property information regarding the target space, corresponding to properties of at least one object in the target space, based on the acquired space data, specify a space of interest in the target space, and determine at least one recommendation object to be placed in the specified space of interest based on the generated property information regarding the target space and a plurality of pieces of property information regarding a plurality of sample spaces; and an output interface configured to output the at least one recommendation object.

### CROSS-REFERENCE TO RELATED APPLICATIONS

This application claims the priority from U.S. Provisional Application No. 62/422,675, filed on Nov. 16, 2016, in the U.S. Patent Office and Korean Patent Application No. 10-2017-0096387, filed on Jul. 28, 2017, in the Korean Intellectual Property Office, the disclosures of which are incorporated herein in their entireties by reference.

### BACKGROUND

### 1. Field

Example embodiments of the present disclosure relate to electronic apparatuses for and methods of placing an object in a space.

### 2. Description of the Related Art

Recently, in the field of computer vision, algorithms or techniques for identifying objects in an image are being provided.

### SUMMARY

One or more example embodiments provide electronic apparatuses for and methods of determining an object that may be placed in a space, or determining a space where an object may be placed, and provide computer-readable recording media having recorded thereon a program for executing the methods.

According to an aspect of an exemplary embodiment, there is provided an electronic apparatus including a processor configured to acquire space data of a target space, generate property information regarding the target space, corresponding to properties of at least one object in the target space, based on the acquired space data, specify a space of interest in the target space, and determine at least one recommendation object to be placed in the specified space of interest based on the generated property information regarding the target space and a plurality of pieces of property information regarding a plurality of sample spaces, respectively, and an output interface configured to output the at least one recommendation object.

The processor may be further configured to: select at least one of the plurality of sample spaces by comparing the generated property information regarding the target space with each piece of property information regarding each of the plurality of sample spaces, and determine the at least one recommendation object to be placed in the specified space of interest based on properties of an object placed in the selected at least one sample space, wherein the target space is a habitable space or a non-habitable space in a building, and the at least one object and the at least one recommendation object are tangible objects.

The processor may be further configured to determine the at least one recommendation object to be placed in the specified space of interest by comparing a size of at least one object in the selected at least one sample space and a size of the specified space of interest.

The processor may be further configured to compare, by using principle component analysis (PCA), properties of an object placed in the each of the plurality of sample spaces, respectively, and properties of an object placed in the target space.

The generated property information regarding the target space may be first property information, and the processor may be further configured to identify the at least one object in the target space based on the acquired space data, and generate second property information corresponding to properties of the identified at least one object.

The output interface may be further configured to display an image including the at least one recommendation object being placed in the specified space of interest.

The processor may be further configured to determine an object of interest based on a user input, and determine a recommendation space within the target space in which the object of interest is to be placed based on the generated property information regarding the target space and the plurality of pieces of property information regarding the plurality of sample spaces, and the output interface may be further configured to output the determined recommendation space.

The processor may be further configured to identify from among the plurality of sample spaces at least one sample space including the object of interest, determine at least one common object of the identified at least one sample space and the target space, and determine the recommendation space within the target space in which the object of interest is to be placed based on a positional relationship between the object of interest and the at least one common object.

The processor may be further configured to determine an object of interest in the target space, and determine a recommendation space in the target space, to which the object of interest is to be placed based on the property information regarding the target space and the plurality of pieces of property information regarding the plurality of sample spaces, and the output interface may be further configured to output the object of interest placed in the determined recommendation space.

The acquired space data may include at least one from among depth information and color information regarding the target space, respectively sensed by a distance sensor and an image sensor.

According to an aspect of another exemplary embodiment, there is provided a method of operating an electronic apparatus, the method including acquiring space data regarding a target space, generating property information regarding the target space, corresponding to properties of at least one object in the target space, based on the acquired space data, specifying a space of interest in the target space, determining at least one recommendation object to be placed in the specified space of interest based on the generated property information regarding the target space and a plurality pieces of property information regarding a plurality of sample spaces, and outputting the at least one recommendation object.

The determining of the at least one recommendation object may include selecting at least one of the plurality of sample spaces by comparing the generated property information regarding the target space and each piece of property information regarding each of the plurality of sample spaces, and determining the at least one recommendation object to be placed in the specified space of interest based on properties of an object placed in the selected at least one sample space wherein the target space is a habitable space or a non-habitable space in a building, and the at least one object and the at least one recommendation object are tangible objects.

The determining of the at least one recommendation object may include determining the at least one recommendation object to be placed in the specified space of interest by comparing a size of at least one object in the selected at least one sample space and a size of the specified space of interest.

The selecting of the at least one of the sample spaces may include comparing, by using principle component analysis (PCA), properties of an object placed in the each of the plurality of sample spaces, respectively, and properties of an object placed in the target space.

The generated property information regarding the target space may be first property information, and the generating of the property information may include identifying the at least one object in the target space based on the acquired space data, and generating second property information corresponding to properties of the identified at least one object.

The outputting of the at least one recommendation object may include displaying an image including the at least one recommendation object being placed in the specified space of interest.

The method may further include determining an object of interest based on a user input, determining a recommendation space within the target space in which the object of interest is to be placed based on the generated property information regarding the target space and the plurality of pieces of property information regarding the plurality of sample spaces, and outputting the determined recommendation space.

The acquired space data may include at least one from among depth information and color information regarding the target space, respectively sensed by a distance sensor and an image sensor.

A computer-readable recording medium, having recorded thereon a program may perform the method on a computer.

According to an aspect of another exemplary embodiment, there is provided an electronic apparatus including a processor configured to acquire space data regarding a target space, the target space being a habitable space or a non- habitable space in a building, specify a space of interest in the target space based on a user input, and determine from among a plurality of tangible objects a recommendation object to be placed in the space of interest based on a size of the space of interest and sizes of the plurality of tangible objects, and an output interface configured to output the recommendation object.

### BRIEF DESCRIPTION OF THE DRAWINGS

The above and/or other aspects will become apparent and more readily appreciated from the following description of example embodiments, taken in conjunction with the accompanying drawings, in which reference numerals denote structural elements:

FIG. 1 illustrates a diagram of an electronic apparatus according to an example embodiment;

FIG. 2 is a flowchart of a method of operating an electronic apparatus, according to an example embodiment;

FIG. 3 is a flowchart of a method, performed by an electronic apparatus, of generating property information regarding a target space, according to an example embodiment;

FIG. 4 illustrates an example where an electronic apparatus generates property information indicating properties of at least one object in a target space, according to an example embodiment;

FIG. 5 illustrates an example where an electronic apparatus determines a recommendation object to be placed in a space of interest, according to an example embodiment;

FIG. 6 illustrates an example where an electronic apparatus compares property information regarding each of a plurality of sample spaces with property information regarding a target space by using principal component analysis (PCA), according to an example embodiment;

FIG. 7 illustrates an example where an electronic apparatus determines a recommendation object to be placed in a space of interest within a target space according to an example embodiment;

FIG. 8 illustrates an example where an electronic apparatus outputs a recommendation object to be placed in a space of interest according to an example embodiment;

FIG. 9 is a flowchart of a method of operating an electronic apparatus according to an example embodiment;

FIG. 10 illustrates an example where an electronic apparatus determines a space appropriate for placement of an object of interest in a target space according to an example embodiment;

FIG. 11 is a flowchart of a method of operating an electronic apparatus according to an example embodiment;

FIG. 12 illustrates an example where an electronic apparatus moves an object of interest in an image of a target space for placement according to an example embodiment;

FIG. 13 is a block diagram of an electronic apparatus according to an example embodiment; and

FIG. 14 is a block diagram of an electronic apparatus according to an example embodiment.

### DETAILED DESCRIPTION

Hereinafter, various example embodiments of the present disclosure will be described in greater detail with reference to the accompanying drawings. These example embodiments are described in sufficient detail to enable those skilled in the art to practice the inventive concept, and it is to be understood that the example embodiments are not intended to limit the present disclosure to particular modes of practice, and it is to be appreciated that all modification, equivalents, and alternatives that do not depart from the spirit and technical scope of the present disclosure are encompassed in the present disclosure.

As used herein, the singular forms “a,” “an” and “the” are intended to include the plural forms as well, unless the context clearly indicates otherwise. The terms “include,” “have,” or “is configured” indicate the presence of features, numbers, steps, operations, elements, and components described in the specification, or a combination thereof, and do not preclude the presence or addition of one or more other features, numbers, steps, operation, elements, or components, or a combination thereof. The term “and/or” includes any combination of a plurality of related listed items or any of the plurality of related listed items.

Also, in the following description, the terms such as “unit” and “module” indicate a unit for processing at least one function or operation, and the unit or the module may be implemented in hardware or software, or a combination of hardware and software. The expression, “at least one of a, b, and c,” should be understood as including only a, only b, only c, both a and b, both a and c, both b and c, or all of a, b, and c.

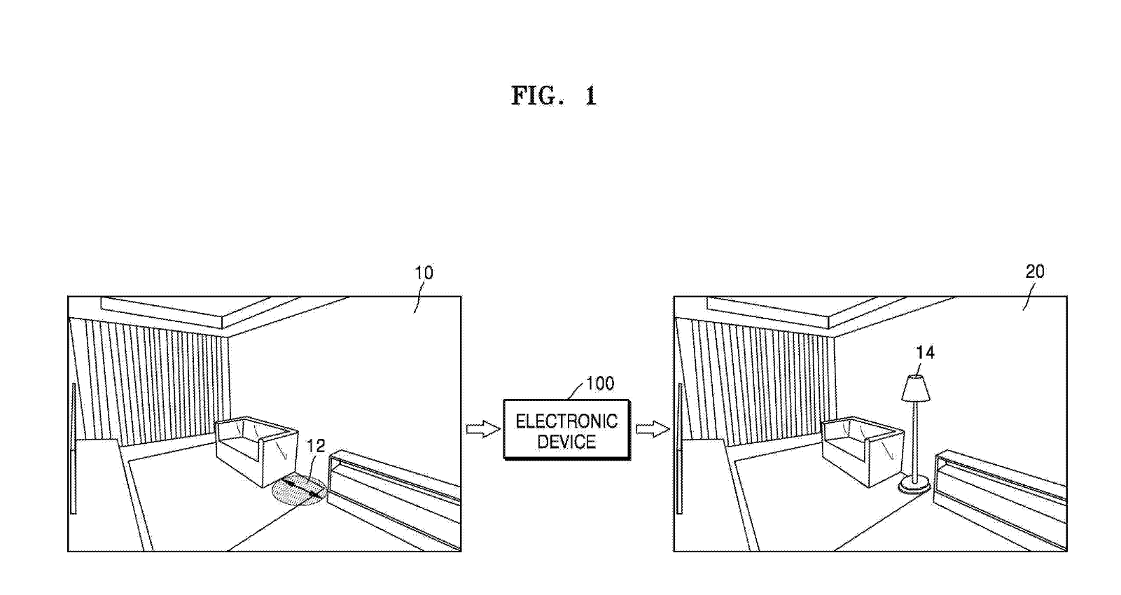

FIG. 1 illustrates an operation of an electronic apparatus 100 according to an example embodiment.

The electronic apparatus 100 may determine a recommendation object to be placed in a space of interest within a target space. A target space may be a space in which at least one object is arranged. For example, the target space may be a living room or kitchen in a house, a lobby in a building, a conference room in an office, etc. In another example embodiment, the target space may be a habitable or a non-habitable space in a building or another structure. An object may be an object, e.g., a tangible object, that can be arranged by a user, such as household appliances, kitchenware, furniture, wallpaper, lighting, carpet, etc. A space of interest may be a partial space within a target space and may be a space where the user desires to place an object.

According to an example embodiment, as shown in FIG. 1, when a space of interest 12 is specified within a target space 10, the electronic apparatus 100 may determine a recommendation object to be placed in the space of interest 12. For example, if a space between sofa and drawer chest is specified as the space of interest 12 within the target space 10, the electronic apparatus 100 may determine a recommendation object which is suitable placement in the space between sofa and drawer chest. According to an example embodiment, the electronic apparatus 100 may determine a recommendation object to be placed in the space of interest 12 by referring to a plurality of sample spaces. A sample space may be a space where objects having recommended properties are arranged. For example, the sample space may be a living room in which furniture or household appliances are arranged, a kitchen where kitchenware is placed, a conference room furnished with office supplies, etc. In detail, the electronic apparatus 100 may select a sample space that has a higher degree of similarity to the target space 10 among a plurality of sample spaces and determine a recommendation object to be placed in the space of interest 12 within the target space 10 by referring to objects in the selected sample space. For example, the electronic apparatus 100 may select, from among a plurality of sample spaces, a sample space including a sofa and a drawer chest as one that has a higher degree of similarity to the target space 10. Then, the electronic apparatus 100 may determine a lampstand positioned between the sofa and the drawer chest within the selected sample space as being a recommendation object 14 to be placed in the space of interest 12.

The electronic apparatus 100 may output the determined recommendation object 14. According to an example embodiment, the electronic apparatus 100 may arrange the recommendation object 14 in the space of interest 12 within the target space 10, and display a target space 20 in which the recommendation object 14 is placed. For example, the electronic apparatus 100 may display the target space 20 in which the recommendation object 14 is placed as a two-dimensional (2D) or three-dimensional (3D) image.

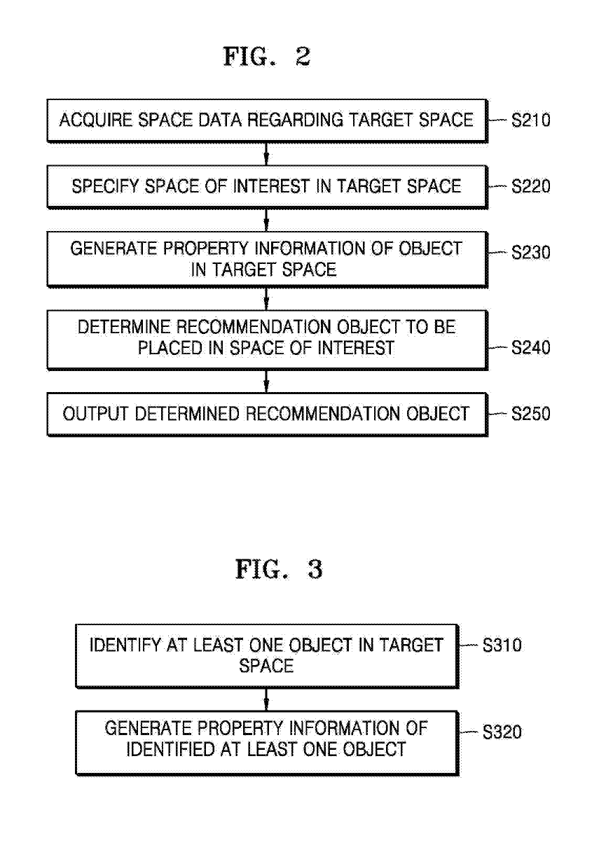

FIG. 2 is a flowchart of a method of operating the electronic apparatus 100 of FIG. 1, according to an example embodiment.

The electronic apparatus 100 may acquire space data regarding a target space (S210). The space data may be used to determine properties of the target space or an object in the target space. For example, the space data may be used to determine a shape, a color, a size, and a position of an object disposed within the target space. The space data may include depth information and color information that can be used to determine properties of the target space or an object in the target space. For example, the space data may include color information regarding the target space, sensed by an image sensor, and distance information thereof sensed by a distance sensor. As another example, the space data may include a distance image and a color image of the target space captured by a red, green, blue plus distance (RGB-D) camera.

According to an example embodiment, the electronic apparatus 100 may include an image sensor and a depth sensor and acquire color information and depth information regarding a target space by sensing the target space via the image sensor and the depth sensor, respectively. In detail, the electronic apparatus 100 may acquire color information regarding the target space via an image sensor and acquire depth information regarding the target space by performing depth sensing on the target space via a depth sensor using a structured light (SL) or time of flight (TOF) method.

According to an example embodiment, the electronic apparatus 100 may acquire space data from an external spatial scanning device. In detail, a spatial scanning device may acquire space data including depth information and color information regarding a target space by sensing the target space and may transmit the acquired space data to the electronic apparatus 100. For example, the spatial scanning device may include an RGB-D camera capable of obtaining both a color image and a distance image of the target space.

The electronic apparatus 100 may specify a space of interest within the target space (S220).

According to an example embodiment, the electronic apparatus 100 may specify a space of interest within the target space based on a user input. In detail, the electronic apparatus 100 may display a 3D image of the target space based on the space data acquired in operation S210. Then, a user may input a space of interest within the target space to the electronic apparatus 100 based on the displayed 3D image, and the electronic apparatus 100 may specify the space of interest based on the user's input. For example, as shown in FIG. 1, the electronic apparatus 100 may specify, based on a user input, an empty space between a sofa and a drawer chest as a space of interest within the target space displayed as a 3D image.

According to an example embodiment, the electronic apparatus 100 may specify a space of interest within the target space by analyzing space data. For example, the electronic apparatus 100 may specify one of empty spaces in the target space as a space of interest by analyzing space data.

The electronic apparatus 100 may generate property information indicating properties of at least one object arranged in the target space (hereinafter, referred to as property information regarding the target space) based on the space data acquired in operation S210 (S230). In detail, the electronic apparatus 100 may identify at least one object placed in the target space by using the space data and generate property information indicating properties of the identified at least one object. According to an example embodiment, properties of an object refer to properties of the object, and may include a shape, a color, a size, a material, and a location of an object in a target space. As another example, the properties of the object may include a product name. Furthermore, the electronic apparatus 100 may create a matrix or vector representing properties of at least one object as property information.

The electronic apparatus 100 may determine at least one recommendation object to be arranged in the space of interest based on the property information regarding the target space generated in operation S230 and pre-stored property information regarding each of a plurality of sample spaces (S240). The plurality of sample spaces may be selected among various sample spaces pre-stored in the electronic apparatus 100 or an external device.

The electronic apparatus 100 may acquire pieces of property information respectively regarding the plurality of sample spaces. In other words, the electronic apparatus 100 may acquire information indicating properties of at least one object disposed in each of the plurality of sample spaces.

The electronic apparatus 100 may select at least one of the plurality of sample spaces by comparing property information regarding each of the plurality of sample spaces with property information regarding the target space.

According to an example embodiment, the electronic apparatus 100 may select a sample space that is most similar to a target space among a plurality of sample spaces. The electronic apparatus 100 may calculate a degree of similarity between property information regarding each of the plurality of sample spaces and property information regarding the target space, and select a sample space that has the highest degree of similarity to the target space among the plurality of sample spaces based on a calculation result. For example, the electronic apparatus 100 may calculate a difference between values for the property information regarding the target space and values for the property information regarding each of the plurality of sample spaces, and select a sample space having a smallest difference among the plurality of sample spaces. The electronic apparatus 100 may then determine a recommendation object to be placed in a space of interest within the target space based on properties of an object disposed in the selected sample space. According to an example embodiment, the electronic apparatus 100 may determine a recommendation object based on properties of an object that is located at a position on a sample space corresponding to a position of a space of interest in the target space. For example, if a space between a sofa and a table is specified as a space of interest and a lampstand is placed between the sofa and the table in a sample space, the electronic apparatus 100 may determine a lampstand having the same model name as that in the sample space as a recommendation object. Furthermore, according to an example embodiment, the electronic apparatus 100 may determine a lampstand having the same color as that in the sample space or a lampstand having the same size as that in the sample space as a recommendation object.

According to an example embodiment, the electronic apparatus 100 may select at least one sample space that has a higher degree of similarity to the target space among the plurality of sample spaces. The electronic apparatus 100 may calculate a degree of similarity between property information regarding each of the plurality of sample spaces with property information regarding the target space, and select at least one sample space that has the highest degree of similarity to the target space based on a calculation result.

The electronic apparatus 100 may then determine a recommendation object to be placed in a space of interest within the target space based on properties of at least one object disposed in the at least one sample space. The electronic apparatus 100 may determine a recommendation object to be placed in a space of interest based on sizes of the at least one object arranged in the at least one sample space. In detail, the electronic apparatus 100 may determine a recommendation object to be placed in the space of interest by comparing a size of the space of interest with those of the at least one object. For example, the electronic apparatus 100 may determine, from among the at least one object, an object having a size less than a width or height of the space of interest as a recommendation object.

Furthermore, the electronic apparatus 100 may determine a recommendation object to be placed in the space of interest by further taking into account properties of an object located near the space of interest. According to an example embodiment, the electronic apparatus 100 may determine a color of a recommendation object based on colors of objects near the space of interest. For example, the electronic apparatus 100 may determine a closet as a recommendation object based on property information regarding the target space and pieces of property information regarding the plurality of sample spaces. For example, when objects near the space of interest have warm-toned colors, such as red and yellow, the electronic apparatus 100 may then determine a color of the recommendation object to be a warm-toned color.

Furthermore, the electronic apparatus 100 may determine a recommendation object to be placed in a space of interest from among a plurality of objects based on a size of the space of interest specified in the target space and sizes of the plurality of objects. In detail, the electronic apparatus 100 may compare a size of each of the plurality of objects with a size of the space of interest, and determine, from among the plurality of objects, an object having a size that may be placed in the space of interest as a recommendation object.

The electronic apparatus 100 may output the at least one recommendation object determined in operation S240 (S250). Furthermore, if a plurality of recommendation objects are determined in operation S240, the electronic apparatus 100 may output the plurality of recommendation objects.

The electronic apparatus 100 may provide the at least one recommendation object determined in operation S240 to the user by displaying them on a screen of the electronic apparatus 100. According to an example embodiment, the electronic apparatus 100 may arrange the at least one recommendation object, determined in operation S240, in the space of interest within the target space and display the target space in which the at least one recommendation object is arranged as an image.

According to an example embodiment, when an existing object in the target space is removed, the electronic apparatus 100 may determine a recommendation object to be placed in a space from which the existing object has been removed. In detail, the electronic apparatus 100 may remove the existing object from the target space based on a user input. The electronic apparatus 100 may then determine a recommendation object to be placed in a space from which the existing object has been removed, based on property information regarding the target space and pieces of property information regarding the plurality of sample spaces. Furthermore, the electronic apparatus 100 may output the determined recommendation object.

Thus, the electronic apparatus 100 may determine a recommendation object to be placed in a specific space within the target space by referring to objects arranged in the plurality of sample spaces and provide the user with the recommendation object suitable for placement of the specific space.

FIG. 3 is a flowchart of a method, performed by the electronic apparatus 100, of generating property information regarding a target space, according to an example embodiment.

The electronic apparatus 100 may identify at least one object in a target space based on space data (S310). According to an example embodiment, the electronic apparatus 100 may identify at least one object in a target space by utilizing an image processing technique using feature points of an object. For example, the electronic apparatus 100 may utilize an image processing technique such as scale-invariant feature transform (SIFT) or speeded up robust features (SURF) for identification of an object. In detail, the electronic apparatus 100 may extract feature points of an object in the target space by using depth information and color information included in the space data. The electronic apparatus 100 may then compare the extracted feature points of the object with pre-stored feature points of each of a plurality of objects. According to an example embodiment, the electronic apparatus 100 may calculate a rigid transformation during comparison between corresponding feature points, and determine an object having a small residual error among the plurality of objects. Thus, the electronic apparatus 100 may identify an object in the target space as being one of the plurality of objects. For example, the electronic apparatus 100 may identify an object in the target space as being a sofa with model number 001 from company A. As another example, the electronic apparatus 100 may identify an object in the target space as being a carpet or wallpaper.

The electronic apparatus 100 may generate property information indicating properties of the at least one object identified in operation S310 (S320).

The electronic apparatus 100 may generate property information including information about a manufacturer or product name of the identified at least one object. For example, since an object may be represented by a manufacturer's product number, property information may include information about a product number assigned to the identified at least one object.

Furthermore, the electronic apparatus 100 may generate property information including information about a shape, a color, a size, a material, and a location in space of the identified at least one object. According to an example embodiment, since properties of an object may be represented as standardized values, the electronic apparatus 100 may determine a standardized value for each property of the object and generate property information including standardized values. For example, if a color of the object is expressed as a standardized RGB color value, the electronic apparatus 100 may generate property information including a standardized RGB color value of the object.

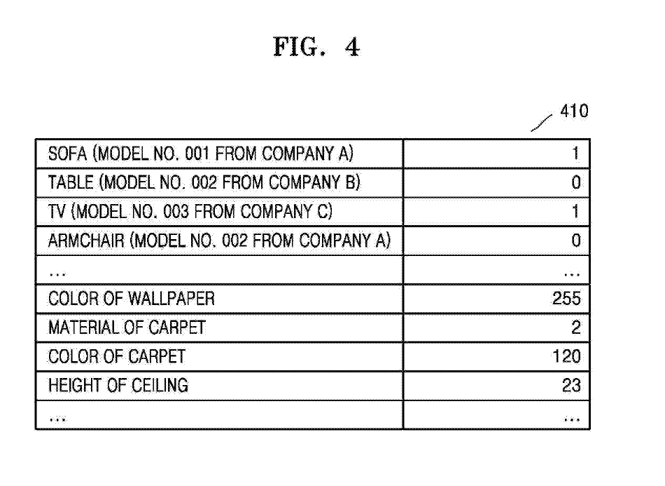

FIG. 4 illustrates an example where the electronic apparatus 100 generates property information indicating properties of at least one object in a target space, according to an example embodiment.

The electronic apparatus 100 may identify at least one object arranged in the target space and generate property information 410 indicating properties of the identified at least one object. According to an example embodiment, the property information 410 may be represented as a matrix.

As a specific example, the electronic apparatus 100 may identify a sofa, a television (TV), wallpaper, a carpet, and a ceiling arranged in the target space by using space data and generate the property information 410 indicating properties of the sofa, TV, wallpaper, carpet, and ceiling.

The electronic apparatus 100 may identify the sofa placed in the target space as being a sofa with model number 001 from company A and the TV adjacent to the a space of interest as being a TV with model number 003 from company C, and generate the property information 410 based on a result of the identifying. In other words, the electronic apparatus 100 may generate the property information 410 including information indicating that the sofa with model number 001 from company A and the TV with model number 003 from company C are present in the target space whereas a table with model number 002 from company B and an armchair with model number 002 from company A do not exist therein.

Furthermore, the electronic apparatus 100 may generate the property information 410 indicating colors of wallpaper and carpet present in the target space. As shown in FIG. 4, the electronic apparatus 100 may generate the property information 410 including information indicating that the wallpaper and the carpet have standardized color values of 255 and 120, respectively.

Furthermore, the electronic apparatus 100 may generate the property information 410 indicating a height of the ceiling of the target space. As shown in FIG. 4, the electronic apparatus 100 may generate the property information 410 including information indicating that the ceiling has a height of 2.3 m.

In addition, the electronic apparatus 100 may generate the property information 410 indicating a material of the carpet present in the target space. As shown in FIG. 4, the electronic apparatus 100 may generate the property information 410 including information indicating that the carpet has a material value of 2.

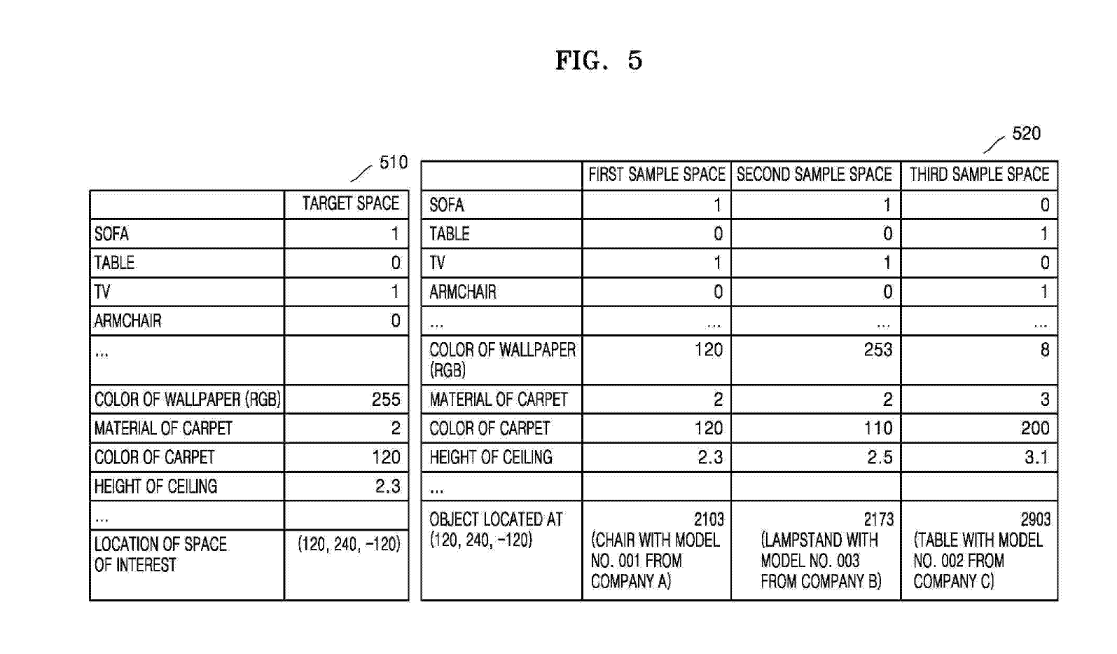

FIG. 5 illustrates an example where the electronic apparatus 100 determines a recommendation object to be placed in a space of interest according to an example embodiment.

The electronic apparatus 100 may determine a recommendation object to be placed in a space of interest within a target space by comparing property information 510 of the target space with property information 520 of each of first through third sample spaces.

First, the electronic apparatus 100 may select at least one of the first through third sample spaces by comparing the property information 520 of each of the first through third sample spaces with the property information 510 of the target space. According to an example embodiment, the electronic apparatus 100 may calculate a degree of similarity between the property information 520 of each of the first through third sample spaces and the property information 510 of the target space, and select a sample space that has the highest degree of similarity to the target space among the first through third sample spaces based on a result of the calculation. For example, if the property information 510 of the target space includes a vector (1,0,1,0) as information indicating the presence/absence of a sofa, a table, a TV, and an armchair, the electronic apparatus 100 may select, from among the first through third sample spaces, a sample space whose property information includes vector (1,0,1,0) as a sample space that has the highest degree of similarity to the target space. Thus, the electronic apparatus 100 may select the first and second sample spaces as sample spaces that have the highest degree of similarity to the target space. As another example, if the property information 510 of the target space includes a vector (255,2,120,2.3) as information indicating values of a color of wallpaper, a material and a color of carpet, and a height of ceiling, the electronic apparatus 100 may calculate a difference between values contained in the vector (255,2,120,2.3) for the target space and their corresponding values for each of the first through third sample spaces, and select a sample space having a smallest difference as a sample space based on a result of the calculating. Thus, the electronic apparatus 100 may select the second sample space as a sample space that has the highest degree of similarity to the target space.

The electronic apparatus 100 may then determine an object that may be placed in the space of interest within the target space by referring to property information regarding the selected sample space. Referring to FIG. 5, when the second sample space is selected as a sample space that has the highest degree of similarity to the target space and a location of the space of interest within the target space is set to coordinates (120,240, −120), the electronic apparatus 100 may determine, based on property information regarding the second sample space, an object located at coordinates (120,240, −120) as a recommendation object to be placed in the space of interest Thus, the electronic apparatus 100 may determine a lampstand with model number 003 from company B as a recommendation object.

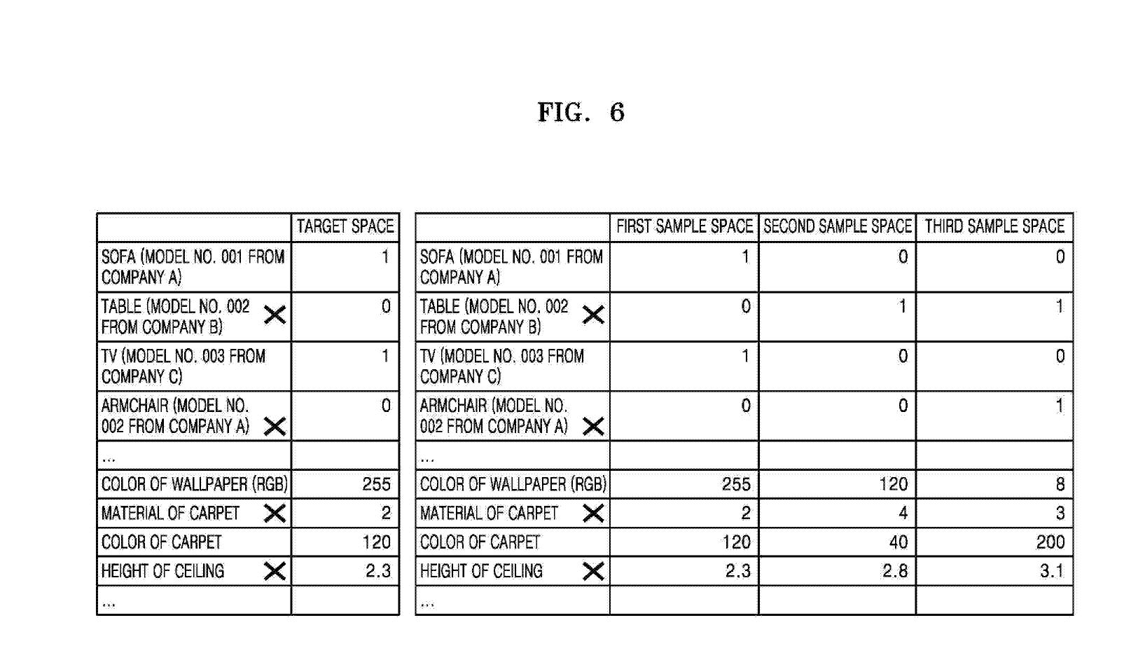

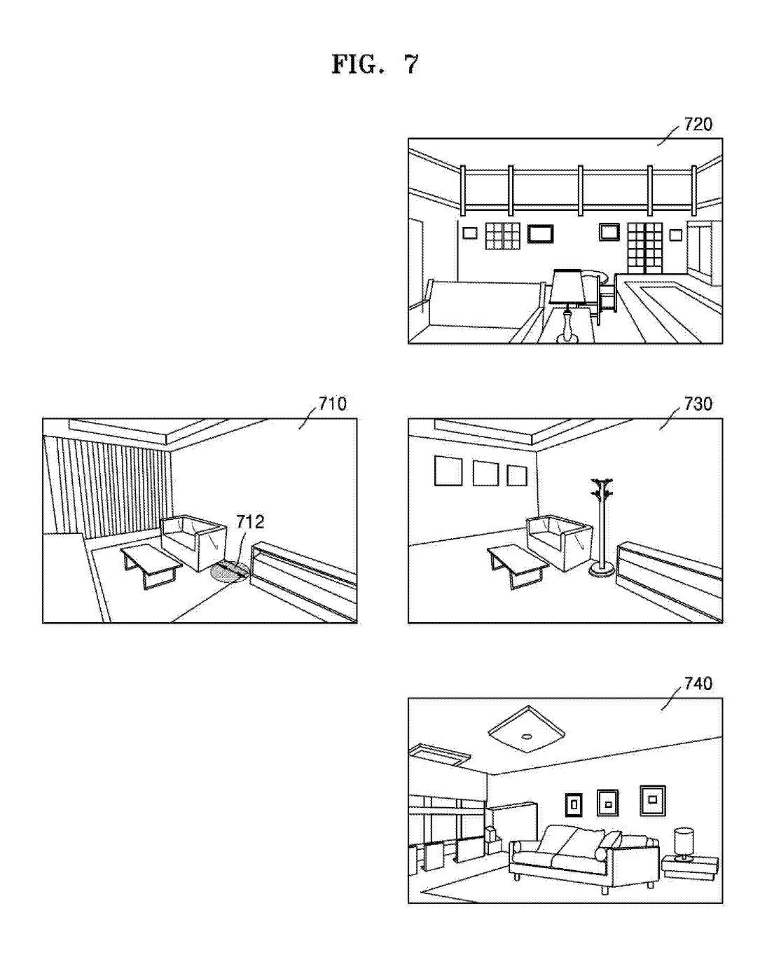

FIG. 6 illustrates an example where the electronic apparatus 100 compares property information regarding each of a plurality of sample spaces with property information regarding a target space by using principal component analysis (PCA) according to an example embodiment.

The electronic apparatus 100 may compare property information regarding each of a plurality of sample spaces with property information regarding a target space by using PCA. In other words, the electronic apparatus 100 may compare properties of an object placed in each of the plurality of sample spaces with those of an object placed in the target space by using PCA.

In detail, by limiting properties to be compared in pieces of property information to main property information, the electronic apparatus 100 may compare property information regarding the target space with property information regarding each of the plurality of sample spaces. For example, as shown in FIG. 6, the electronic apparatus 100 may calculate a degree of similarity between the property information regarding the target space and that of each of the plurality of sample spaces based on properties (presence/absence of sofa and TV and colors of wallpaper and carpet) considered to be main property information among properties to be compared in the pieces of property information (presence/absence of sofa, TV, table, and armchair, color of wallpaper, material and color of carpet, and height of ceiling)

Thus, since it is possible to shorten a computation time by reducing the number of computations required for comparison between the property information regarding the target space and that of each of the plurality of sample spaces, the electronic apparatus 100 may determine a recommendation object to be placed in a space of interest in real time.

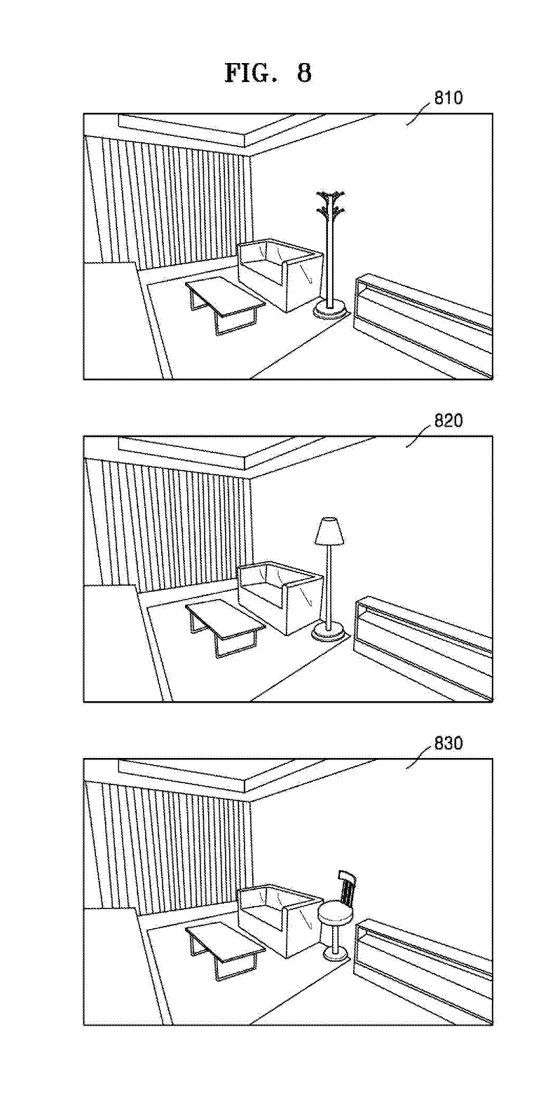

FIG. 7 illustrates an example where the electronic apparatus 100 determines a recommendation object to be placed in a space of interest 712 within a target space 710 according to an example embodiment.

The electronic apparatus 100 may specify the space of interest 712 within the target space 710.

The electronic apparatus 100 may then determine a recommendation object to be placed in the space of interest 712 by comparing property information regarding the target space 710 with that of each of sample spaces 720, 730, and 740.

First, the electronic apparatus 100 may select a sample space that has the highest degree of similarity to the target space 710 among the sample spaces 720, 730, and 740 based on a degree of similarity between property information regarding the target space 710 and that of each of the sample spaces 720, 730, and 740. According to an example embodiment, the property information regarding the target space 710 may include information indicating that the target space 710 includes a sofa, a table, and a drawer chest. According to another example embodiment, the property information regarding the target space 710 may include information about a relationship between positions of the sofa, the table, and the drawer chest. For example, the property information regarding the target space 710 may include information indicating that the table is positioned in front of the sofa and information indicating that the drawer chest is positioned next to the sofa. Thus, according to an example embodiment, by referring to pieces of property information regarding the sample spaces 720, 730, and 740, the electronic apparatus 100 may select, from among the sample spaces 720, 730, and 740, a sample space 730 including the sofa, the table, and the drawer chest as a sample space that is the highest degree of similarity to the target space 710. Furthermore, according to another embodiment, by referring to the pieces of property information regarding the sample spaces 720, 730, and 740, the electronic apparatus 100 may select a sample space 730 in which positions of the sofa, the table, and the drawer chest have a similar relationship to those of their corresponding objects in the target space 710 as a sample space that has the highest degree of similarity to the target space 710.

Then, the electronic apparatus 100 may determine a recommendation object to be placed in the space of interest 712 within the target space 710 by referring to property information regarding the sample space 730. According to an example embodiment, the electronic apparatus 100 may determine a recommendation object to be placed in the space of interest 712 within the target space 710 based on properties of a stand hanger located at a position on the sample space 730 corresponding to a position of the space of interest 712 in the target space 710. For example, the electronic apparatus 100 may determine a stand hanger of the same model as that in the sample space 730 as a recommendation object. As another example, the electronic apparatus 100 may determine a stand hanger having the same color as that in the sample space 730 as a recommendation object.

FIG. 8 illustrates an example where the electronic apparatus 100 outputs a recommendation object to be placed in a space of interest according to an example embodiment.

The electronic apparatus 100 may determine a stand hanger as a recommendation object to be placed in the space of interest 712 within the target space 710 as described with reference to FIG. 7, and display a target space 810 in which the stand hanger is disposed.

Furthermore, the electronic apparatus 100 may determine a lampstand and a chair as recommendation objects to be arranged in the space of interest 712 within the target space 710 by referring to pieces of property information regarding sample spaces other than the sample spaces 720, 730, and 740 and display target spaces 820 and 830 in which the lampstand and the chair are respectively arranged.

Thus, the user may then view the target spaces 810, 820, and 830 in which objects, i.e., the stand hanger, the lampstand, and the chair are respectively arranged and select a desired object among the objects.

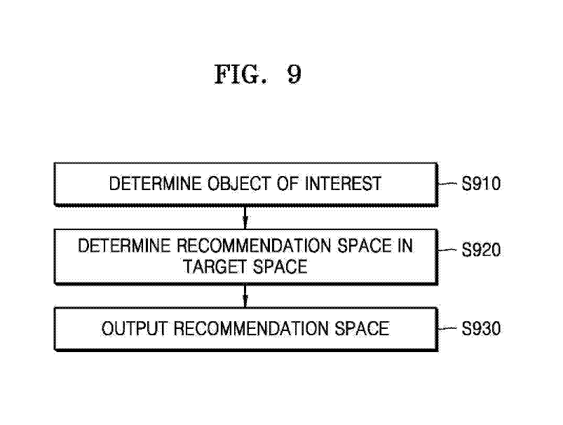

FIG. 9 is a flowchart of a method of operating the electronic apparatus 100 according to an example embodiment.

The electronic apparatus 100 may specify an object of interest (S910).

According to an example embodiment, the electronic apparatus 100 may determine an object of interest based on a user input. In detail, a user may input information about an object of interest to be placed in a target space to the electronic apparatus 100 and determine the object of interest based on the user's input. For example, the electronic apparatus 100 may display a list of a plurality of objects on a screen and determine an object of interest among the plurality of objects based on a user input.

The electronic apparatus 100 may determine a recommendation space within a target space, where the object of interest is to be placed, based on property information regarding the target space and pieces of property information regarding a plurality of sample spaces (S920).

According to an example embodiment, the electronic apparatus 100 may identify, based on pieces of property information regarding a plurality of sample spaces, at least one sample space including an object of interest among the plurality of sample spaces. The electronic apparatus 100 may then determine at least one object that the at least one sample space and the target space have in common. Subsequently, the electronic apparatus 100 may determine a recommendation space in the target space, where the object of interest is to be placed, based on a relative positional relationship between the object of interest and the at least one object within the at least one sample space. In detail, since property information regarding the at least one sample space may include position information regarding each object in the at least one sample space, the electronic apparatus 100 may recognize a relative positional relationship between the object of interest and the at least one object within the at least one sample space based on the property information regarding the at least one sample space. The electronic apparatus 100 may then determine a recommendation space within the target space, where the object of interest is to be placed, by applying the relative positional relationship between the object of interest and the at least one object to the target space. For example, if an object of interest is a sofa, the electronic apparatus 100 may recognize information indicating that the sofa is located 3 meters in front of a TV within a sample space. The electronic apparatus 100 may then determine a space that is located 3 meters in front of a TV in a target space as a recommendation space.

According to an example embodiment, the electronic apparatus 100 may determine a recommendation space in a target space where an object of interest is to be placed based on characteristics of the object of interest. For example, if an object of interest is a type of household appliance, the electronic apparatus 100 may determine a space adjacent to a position of a power outlet, which is one of objects in a target space, as a recommendation space. As another example, if an object of interest is a kitchenware object, the electronic apparatus 100 may determine a space adjacent to a position of another kitchenware object among objects in a target space as a recommendation space. Furthermore, the electronic apparatus 100 may determine a recommendation space in a target space, in which an object of interest is to be placed, by further taking into account characteristics of a user as well as properties of the object of interest. Characteristics of a user may include a user's gender, age, moving route, etc. A user's moving route may be a history of a route along which the user has traveled within a target space. For example, if the object of interest is a kitchenware object, and the user is a housewife, the electronic apparatus 100 may determine a space near a position where the user often stays as a recommendation space, based on information regarding previously acquired information about a user's moving route.

According to an example embodiment, when properties of an existing object in a target space are changed, the electronic apparatus 100 may change properties of another object in the target space. For example, if the electronic apparatus 100 changes a color of an existing object in a target space from a warm-toned color to a cool-toned color, such as blue and purple, based on a user input, the electronic apparatus 100 may change a color of an object in the vicinity of the existing object from a warm-toned color to a cool-toned color, accordingly.

The electronic apparatus 100 may output the recommendation object determined in operation S920 (S930). Furthermore, when a plurality of recommendation spaces are determined in operation S920, the electronic apparatus 100 may output the plurality of recommendation spaces.

The electronic apparatus 100 may arrange the object of interest in the recommendation space determined in operation S920, and then display the arrangement to the user. In other words, the electronic apparatus 100 may place the object of interest in the recommendation space within the target space and display the target space in which the object of interest is placed as an image.

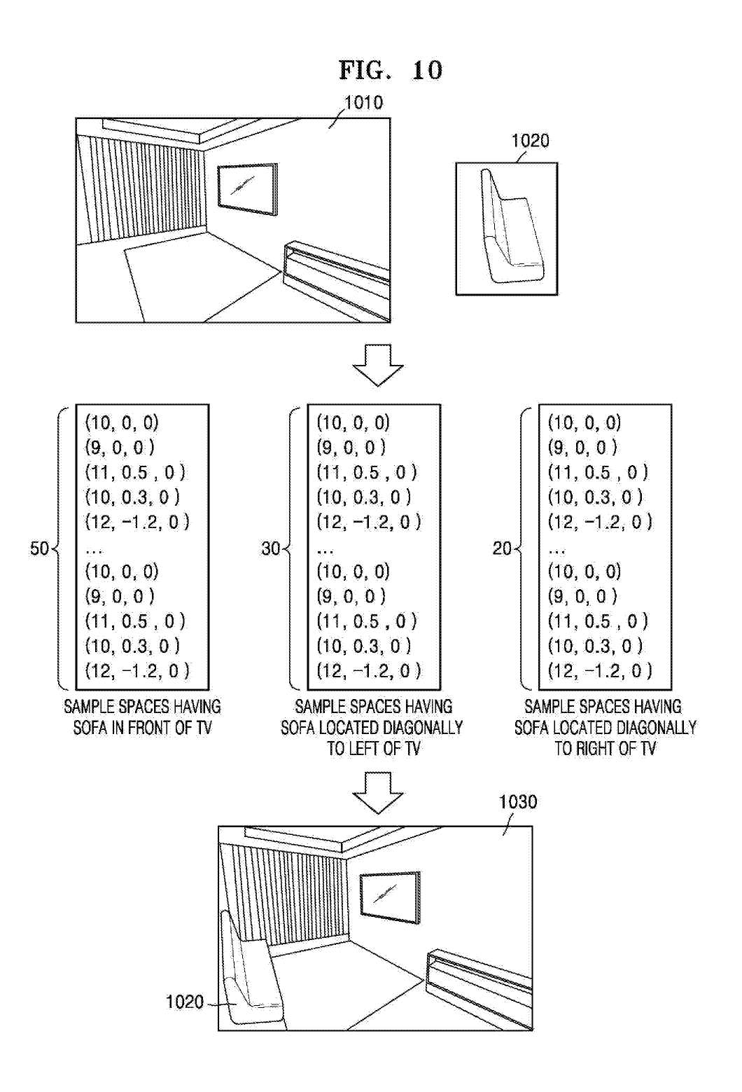

FIG. 10 illustrates an example where the electronic apparatus 100 determines a space appropriate for placement of an object of interest in a target space according to an example embodiment.

The electronic apparatus 100 may specify a sofa as an object of interest 1020 and determine a recommendation space within a target space 1010, in which the object of interest 1020 is to be placed, based on property information regarding the target space 1010 and pieces of property information regarding a plurality of sample spaces.

The electronic apparatus 100 may identify at least one sample space including the object of interest 1020 among the plurality of sample spaces and determine at least one object that the at least one sample space and the target space 1010 have in common. For example, the electronic apparatus 100 may determine a TV as the at least one object.

The electronic apparatus 100 may then recognize a relative positional relationship between the object of interest 1020 and the at least one object within the at least one sample space. For example, the electronic apparatus 100 may recognize a relative positional relationship between the sofa and the TV in the at least one sample space. In detail, referring to FIG. 10, the electronic apparatus 100 may recognize fifty (50) sample spaces in which the sofa is located in front of the TV, thirty (30) sample spaces in which the sofa is located diagonally to the left of the TV, and twenty (20) sample spaces in which the sofa is located diagonally to the right of the TV, and acquire information about a position vector of the sofa with respect to the TV in each sample space.

Subsequently, the electronic apparatus 100 may determine a recommendation space within the target space 1010 where the object of interest 1020 is to be placed by applying the relative positional relationship between the object of interest 1020 and the at least one object to the target space 1010. According to an example embodiment, the electronic apparatus 100 may determine a space in which the sofa is located in front of the TV as a recommendation space based on the 50 sample spaces that occupy a large percentage of one hundred (100) sample spaces. Furthermore, the electronic apparatus 100 may determine a recommendation space within the target space 1010 in which the object of interest 1020 is to be placed by using position vectors in the 50 sample spaces. For example, the electronic apparatus 100 may determine an average value of the position vectors in the 50 sample spaces as being (9.5, 0.2, 0) and then determine a space located at (9.5, 0.2, 0) with respect to the TV in the target space 1010 to be a recommendation space.

Thus, the electronic apparatus 100 may display a target space 1030 in which the object of interest 1020 is placed in the determined recommendation as an image.

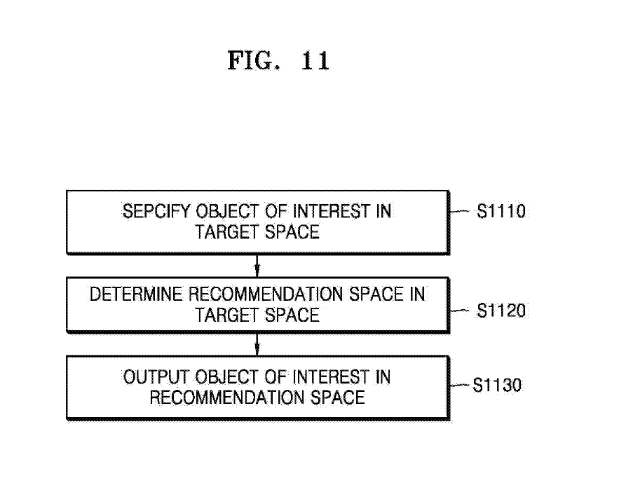

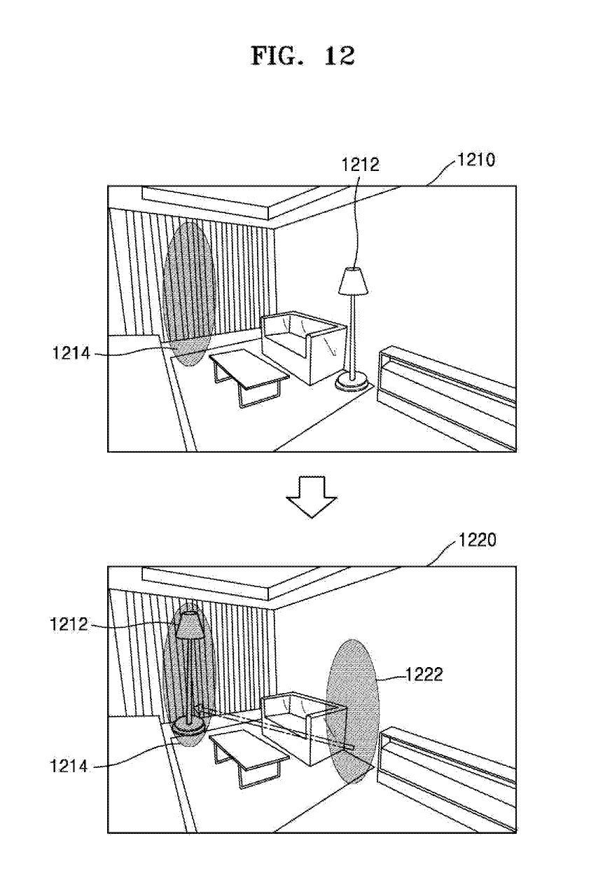

FIG. 11 is a flowchart of a method of operating the electronic apparatus 100 according to an example embodiment.

The electronic apparatus 100 may specify an object of interest in a target space (S1110).

According to an example embodiment, the electronic apparatus 100 may specify an object of interest based on a user input. In detail, a user may input information about an object of interest that is to be moved for new placement to the electronic apparatus 100 by referring to an image of the target space displayed by the electronic apparatus 100, and the electronic apparatus 100 may specify the object of interest based on the user's input.

The electronic apparatus 100 may determine a recommendation space in the target space to which the object of interest is to be moved for placement based on property information regarding the target space and pieces of property information regarding a plurality of sample spaces (S1120). In other words, the electronic apparatus 100 may determine a recommendation space in the target space where an existing object of interest is to be newly placed. For example, according to operation S920 and the example embodiment described with reference to FIG. 10, the electronic apparatus 100 may determine a recommendation space in the target space to which the object of interest is to be moved for placement based on the property information regarding the target space and the pieces of property information regarding the plurality of sample spaces.

The electronic apparatus 100 may output the object of interest placed in the determined recommendation space (S1130). According to an example embodiment, the electronic apparatus 100 may display an image of the target space from which an existing object of interest has been removed. The object of interest may be displayed as being located in the determined recommendation space.

In order to display the target space where an existing object of interest is removed, the electronic apparatus 100 may reconstruct a space in which the existing object of interest has previously been placed into an empty space in the image of the target space.

First, the electronic apparatus 100 may detect at least one object in an image of the target space based on space data regarding the target space. According to an example embodiment, the electronic apparatus 100 may detect a floor, a ceiling, and a wall in an image of the target space based on space data regarding the target space. For example, the electronic apparatus 100 may create a mesh from a point cloud in the image of the target space, and detect a floor, a ceiling, and a wall in the image of the target space by using the created mesh or depth data regarding the target space. Furthermore, the electronic apparatus 100 may detect at least one object in the image of the target space based on image features such as corners or edges. In particular, the electronic apparatus 100 may detect a vanishing point blocked by an object of interest in the image of the target space, based on a corner or edge in the object of interest. Furthermore, the electronic apparatus 100 may detect a point blocked by the object of interest in the image of the target space by using perspective projection based on calibration.

The electronic apparatus 100 may then reconstruct a space in which the object of interest has previously been placed into an empty space based on information about a floor/ceiling/wall in the image of the target space or information about a point blocked by the object of interest. In other words, the electronic apparatus 100 may reconstruct a space where the object of interest has previously been placed into an empty space in the image of the target space by estimating a background blocked by the object of interest.

As described above, the electronic apparatus 100 may reconstruct a space in which the object of interest has previously been placed into an empty space while at the same time displaying the target space where the object of interest is placed in a recommendation space. Thus, it is possible to achieve an effect similar to displaying a target space where the object of interest is moved to the recommendation space.

FIG. 12 illustrates an example where the electronic apparatus 100 moves an object of interest in an image of a target space for placement according to an example embodiment.

The electronic apparatus 100 may display an image 1210 of a target space. The electronic apparatus 100 may also specify a lampstand 1212 in the target space. According to an example embodiment, a user may input information about the lampstand 1212 to the electronic apparatus 100 by referring to the image 1210 of the target space, and specify the lampstand 1212 based on the user's input.

The electronic apparatus 100 may determine a recommendation space 1214 in the target space where the lampstand 1212 is to be moved for placement, based on property information regarding the target space and pieces of property information regarding a plurality of sample spaces.

As seen on an image 1220, the electronic apparatus 100 may display a target space where the lampstand 1212 is placed in the determined recommendation space 1214. In detail, the electronic apparatus 100 may reconstruct a space 1222 in which the lampstand 1212 has previously been placed into an empty space and display the target space where the lampstand 1212 is placed in the recommendation space 1214.

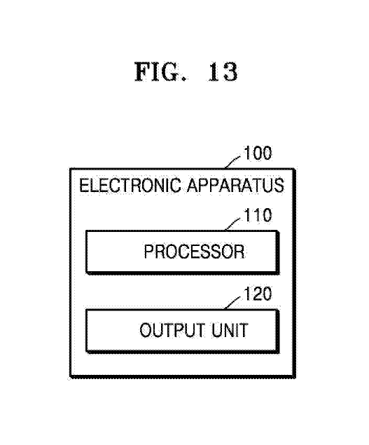

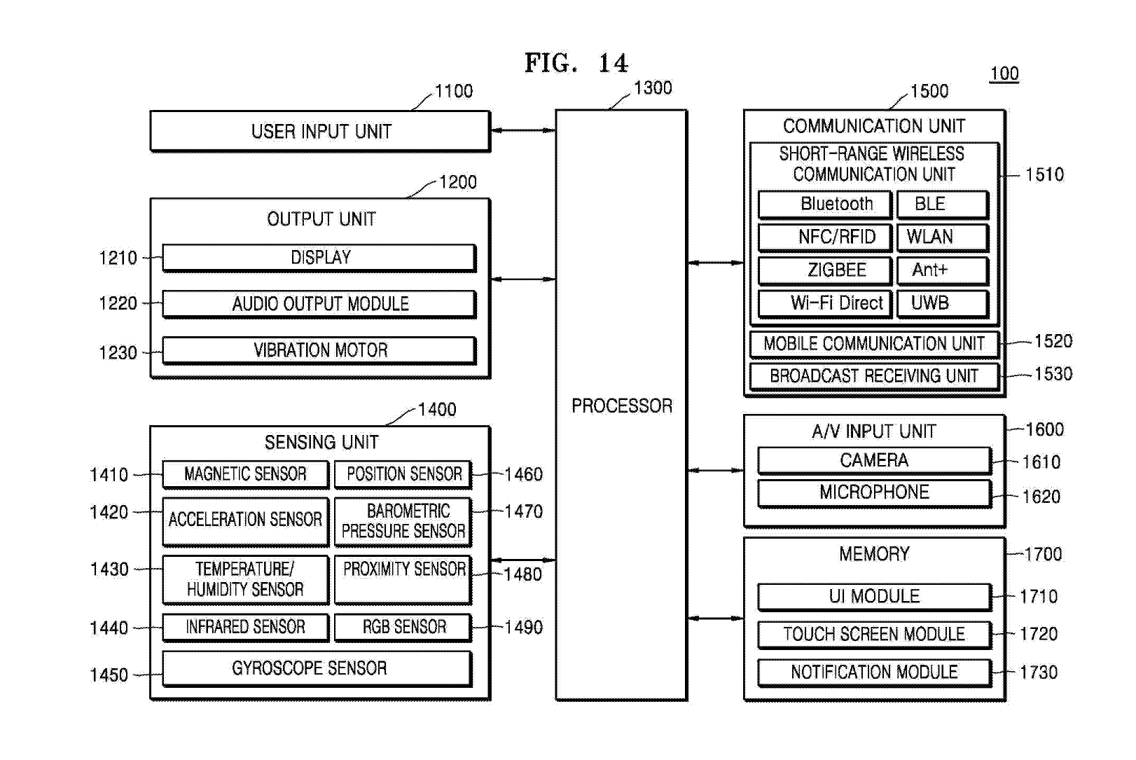

FIG. 13 is a block diagram of an electronic apparatus 100 according to an example embodiment.

According to an example embodiment, the electronic apparatus 100 may include a processor 110 and an output interface 120. Although the electronic apparatus 100 of FIG. 13 includes components related to an example embodiment, it will be understood by those of ordinary skill in the art that the electronic apparatus 100 may further include components other than those shown in FIG. 13.

The processor 110 may acquire space data regarding a target space. The space data may include depth information and color information.

The processor 110 may also specify a space of interest in the target space. According to an example embodiment, the electronic apparatus 100 may specify the space of interest in the target space based on a user input. According to another example embodiment, the electronic apparatus 100 may specify the space of interest in the target space by analyzing the space data.

The processor 110 may then generate property information indicating properties of at least one object arranged in the target space based on the acquired space data. In detail, the processor 110 may identify at least one object in the target space and generate property information indicating properties of the identified at least one object.

The processor 110 may also determine at least one recommendation object to be placed in the space of interest based on property information regarding the target space and pieces of property information regarding a plurality of sample spaces. In detail, the processor 110 may select at least one of the plurality of sample spaces by comparing the property information regarding the target space with property information regarding each of the plurality of sample spaces. The processor 110 may then determine at least one recommendation object to be placed in the space of interest based on properties of an object in the selected at least one sample space. According to an example embodiment, the processor 110 may determine at least one recommendation object to be placed in the space of interest based on properties of an object that is located at a position on a sample space corresponding to a position of the space of interest in the target space.

The output interface 120 may output a recommendation object determined by the processor 110. Furthermore, when a plurality of recommendation objects are determined by the processor 110, the output interface 120 may output the plurality of recommendation objects. The output interface 120 may provide the recommendation object determined by the processor 110 to the user by displaying the recommendation object.

According to an example embodiment, the processor 110 may specify an object of interest. The processor 110 may specify the object of interest based on a user input.

The processor 110 may determine a recommendation space in the target space where an object of interest is to be placed based on the property information regarding the target space and the pieces of property information regarding the plurality of sample spaces. In detail, the processor 110 may identify at least one sample space including the object of interest among the plurality of sample spaces, based on the pieces of property information regarding the plurality of sample spaces. The processor 110 may then determine at least one object that the at least one sample space and the target space have in common. Subsequently, the processor 110 may determine a recommendation space in the target space, where the object of interest is to be placed, based on a relative positional relationship between the object of interest and the at least one object within the at least one sample space.

The output interface 120 may output a recommendation object determined by the processor 110. Furthermore, when a plurality of recommendation objects are determined by the processor 110, the output interface 120 may output the plurality of recommendation objects.

According to an example embodiment, the processor 110 may specify an object of interest in a target space. The processor 110 may specify an object of interest which is to be moved for placement based on a user input.

The processor 110 may determine a recommendation space in the target space to which the object of interest is to be moved for placement based on property information regarding the target space and pieces of property information regarding a plurality of sample spaces. In other words, the processor 110 may determine a recommendation space in the target space where an existing object of interest is to be newly placed.

The output interface 120 may output the object of interest placed in the recommendation space determined by the processor 110. According to an example embodiment, the output interface 120 may display the target space from which an existing object of interest has been removed. The object of interest may be displayed as being located in the determined recommendation space. In order to display the target space where an existing object of interest is removed, the electronic apparatus 100 may reconstruct a space in which the existing object of interest has previously been placed into an empty space in the image of the target space.

The processor 110 may acquire not only space data regarding the target space but also data regarding a plurality of objects. Then, the processor 110 may determine a recommendation object to be placed in a space of interest within the target space from among a plurality of objects based on sizes of the space of interest and the plurality of objects. In detail, the processor 110 may compare a size of each of the plurality of objects with the size of the space of interest and determine an object having a size suitable for placement in the space of interest as a recommendation object from among the plurality of objects.

FIG. 14 is a block diagram of an electronic apparatus 100 according to an example embodiment.

Referring to FIG. 14, the electronic apparatus 100 may include a user input unit 1100, an output interface 1200, a processor 1300, a sensing unit 1400, a communication unit 1500, an audio/video (A/V) input unit 1600, and a memory 1700. Since the processor 1300 and the output interface 1200 of FIG. 14 respectively correspond to the processor 110 and the output interface 120 of FIG. 13, descriptions that are already provided above with respect to FIG. 13 are omitted here.

The user input unit 1100 is a device via which the user inputs data necessary for controlling the electronic apparatus 100. Examples of the user input unit 1100 may include, but are not limited to, a keypad, a dome switch, a touch pad (a capacitive overlay type, a resistive overlay type, an infrared beam type, a surface acoustic wave type, an integral strain gauge type, a piezoelectric type, etc.), a jog wheel, and a jog switch. For example, the user input unit 1100 may receive a user input for performing payment of goods based on a vehicle identification number.

The output interface 1200 may output an audio signal, a video signal, or a vibration signal. The output interface 1200 may include a display 1210, an audio output module 1220, and a vibration motor 1230.

The display 1210 may display and output information processed by the electronic apparatus 100. For example, the display 1210 may display a graphical user interface (GUI) for performing payment on goods based on a vehicle identification number.

In addition, when the display 1210 and a touch pad form a layer structure to form a touch screen, the display 1210 may be used as an input device as well as an output device.

The audio output module 1220 may output audio data received from the communication unit 1500 or stored in the storage 1700. The vibration motor 1230 may output a vibration signal.

The processor 1300 controls all operations of the electronic apparatus 100. For example, the processor 1300 may control the user input unit 1100, the display 1210, and the communication unit 1500 in its entirety by executing programs stored in the memory 1700.

The sensing unit 1400 may detect a status of the electronic apparatus 100 or a status of an environment around the electronic apparatus 100, and transmit the detected status to the processor 1300.

The sensing unit 1400 may include at least one of a magnetic sensor 1410, an acceleration sensor 1420, a temperature/humidity sensor 1430, an infrared sensor 1440, a gyroscope sensor 1450, a position sensor (e.g., GPS) 1460, a barometric pressure sensor 1470, a proximity sensor 1480, and an RGB sensor (an illuminance sensor) 1490, but is not limited thereto.

The communication unit 1500 may include a short-range wireless communication unit 1510, a mobile communication unit 1520, and a broadcast receiving unit 1530.

The short-range wireless communication unit 1510 may include a Bluetooth communication module, a Bluetooth Low Energy (BLE) communication module, a Near Field Communication (NFC) module, a wireless local area network (WLAN) communication module, a Zigbee communication module, an Infrared Data Association (IrDA) communication module, a Wi-Fi Direct (WFD) communication module, a Ultra-wideband (UWB) communication module, and an Ant+communication module, but is not limited thereto.

The mobile communication unit 1520 may transmit or receive a wireless signal to or from at least one of a base station, an external terminal, and a server in a mobile communication network. The wireless signal may be, for example, a voice call signal, a video call signal, or data in any one of various formats according to transmission and reception of a text/multimedia message.

The broadcast receiving unit 1530 may receive broadcast signals and/or broadcast-related information from the outside via a broadcast channel. The broadcast channel may include a satellite channel, a terrestrial channel, etc.

The memory 1700 may store programs necessary for processing or control operations performed by the processor 1300 or store data input to or output from the electronic apparatus 100.

The memory 1700 may include at least one storage medium from among a flash memory-type memory, a hard disk-type memory, a multimedia card micro-type memory, card-type memories (e.g., an SD card, an XD memory, and the like), random access memory (RAM), static RAM (SRAM), read-only memory (ROM), electrically erasable programmable ROM (EEPROM), PROM, magnetic memory, a magnetic disc, and an optical disc.

The programs stored in the memory 1700 may be classified into a plurality of modules according to their functions. For example, the programs may be classified into a user interface (UI) module 1710, a touch screen module 1720, and a notification module 1730.

The UI module 1710 may provide a specialized UI, a GUI, etc. interworking with the mobile device for each application. The touch screen module 1720 may detect a user's touch gesture on a touch screen and transmit information of the detected touch gesture to the processor 1300. According to example embodiments, the touch screen module 1720 may recognize a touch code for analysis. The touch screen module 1720 may be formed by separate hardware components including a controller.

Examples of the above-described apparatus include a processor, a memory for storing and executing program data, a permanent storage such as a disc drive, a communication port for communicating with external devices, and a UI device such as a touch panel, keys, or buttons. Methods implemented by using software modules or algorithms may be stored as computer-readable codes executable by the processor or program instructions on a computer-readable recording medium. Examples of the computer-readable recording medium include magnetic storage media (e.g., ROM, RAM, floppy disks, hard disks, etc.) and optical recording media (e.g., CD-ROMs and Digital Versatile Discs (DVDs)). The computer- readable recording medium may also be distributed over network-coupled computer systems so that the computer-readable codes are stored and executed in a distributed fashion. The computer-readable recording medium can be read by a computer, function as a memory, and be executed by the processor.

The example embodiments may be described in terms of functional block components and various processing steps. Such functional blocks may be realized by any number of hardware and/or software components configured to perform the specified functions. For example, the example embodiments may employ various integrated circuit components, e.g., memory elements, processing elements, logic elements, look-up tables, and the like, which may carry out a variety of functions under the control of one or more microprocessors or other control devices. Similarly to where the elements of the example embodiments can be implemented using software programming or software elements, the example embodiments may be implemented with any programming or scripting language such as C, C++, Java, assembler, or the like, with the various algorithms being implemented with any combination of data structures, processes, routines or other programming elements. Functional aspects may be implemented in algorithms that are executed on one or more processors. Furthermore, the example embodiments may employ any number of conventional techniques for electronic configuration, signal processing and/or data processing.

Example embodiments have been shown and described, however, it will be understood by those skilled in the art that various changes in form and details may be made therein without departing from the spirit and scope of the present disclosure as described by the appended claims, and their equivalents.

What is claimed is:

1. An electronic apparatus comprising:
a processor configured to:
acquire space data of a target space,
generate property information regarding the target space, corresponding to properties of at least one object in the target space, based on the acquired space data,
specify a space of interest in the target space, and
determine at least one recommendation object to be placed in the specified space of interest based on the generated property information regarding the target space and a plurality of pieces of property information regarding a plurality of sample spaces, respectively; and
an output interface configured to output the at least one recommendation object.

2. The electronic apparatus of claim 1, wherein the target space is a habitable space or a non-habitable space in a building, and the at least one object and the at least one recommendation object are tangible objects, and
wherein the processor is further configured to:
select at least one of the plurality of sample spaces by comparing the generated property information regarding the target space with each piece of property information regarding each of the plurality of sample spaces; and
determine the at least one recommendation object to be placed in the specified space of interest based on properties of an object placed in the selected at least one sample space.

3. The electronic apparatus of claim 2, wherein the processor is further configured to determine the at least one recommendation object to be placed in the specified space of interest by comparing a size of at least one object in the selected at least one sample space and a size of the specified space of interest.

4. The electronic apparatus of claim 2, wherein the processor is further configured to compare, by using principle component analysis (PCA), properties of an object placed in the each of the plurality of sample spaces, respectively, and properties of an object placed in the target space.

5. The electronic apparatus of claim 1, wherein the generated property information regarding the target space is first property information, and
wherein the processor is further configured to:
identify the at least one object in the target space based on the acquired space data, and
generate second property information corresponding to properties of the identified at least one object.

6. The electronic apparatus of claim 1, wherein the output interface is further configured to display an image comprising the at least one recommendation object being placed in the specified space of interest.

7. The electronic apparatus of claim 1, wherein the processor is further configured to:
determine an object of interest based on a user input; and
determine a recommendation space within the target space in which the object of interest is to be placed based on the generated property information regarding the target space and the plurality of pieces of property information regarding the plurality of sample spaces, and
wherein the output interface is further configured to output the determined recommendation space.

8. The electronic apparatus of claim 7, wherein the processor is further configured to:
identify from among the plurality of sample spaces at least one sample space comprising the object of interest;
determine at least one common object of the identified at least one sample space and the target space; and
determine the recommendation space within the target space in which the object of interest is to be placed based on a positional relationship between the object of interest and the at least one common object.

9. The electronic apparatus of claim 1, wherein the processor is further configured to:
determine an object of interest in the target space; and
determine a recommendation space in the target space, to which the object of interest is to be placed based on the property information regarding the target space and the plurality of pieces of property information regarding the plurality of sample spaces, and
wherein the output interface is further configured to output the object of interest placed in the determined recommendation space.

10. The electronic apparatus of claim 1, wherein the acquired space data comprises at least one from among depth information and color information regarding the target space, respectively sensed by a distance sensor and an image sensor.

11. A method of operating an electronic apparatus, the method comprising:
acquiring space data regarding a target space;
generating property information regarding the target space, corresponding to properties of at least one object in the target space, based on the acquired space data;
specifying a space of interest in the target space;
determining at least one recommendation object to be placed in the specified space of interest based on the generated property information regarding the target space and a plurality pieces of property information regarding a plurality of sample spaces; and
outputting the at least one recommendation object.

12. The method of claim 11, wherein the target space is a habitable space or a non-habitable space in a building, and the at least one object and the at least one recommendation object are tangible objects, and
wherein the determining of the at least one recommendation object comprises:
selecting at least one of the plurality of sample spaces by comparing the generated property information regarding the target space and each piece of property information regarding each of the plurality of sample spaces; and
determining the at least one recommendation object to be placed in the specified space of interest based on properties of an object placed in the selected at least one sample space.

13. The method of claim 12, wherein the determining of the at least one recommendation object comprises determining the at least one recommendation object to be placed in the specified space of interest by comparing a size of at least one object in the selected at least one sample space and a size of the specified space of interest.

14. The method of claim 12, wherein the selecting of the at least one of the sample spaces comprises comparing, by using principle component analysis (PCA), properties of an object placed in the each of the plurality of sample spaces, respectively, and properties of an object placed in the target space.

15. The method of claim 11, wherein the generated property information regarding the target space is first property information, and
wherein the generating of the property information comprises:
identifying the at least one object in the target space based on the acquired space data; and
generating second property information corresponding to properties of the identified at least one object.

16. The method of claim 11, wherein the outputting of the at least one recommendation object comprises displaying an image comprising the at least one recommendation object being placed in the specified space of interest.

17. The method of claim 11, further comprising:
determining an object of interest based on a user input;
determining a recommendation space within the target space in which the object of interest is to be placed based on the generated property information regarding the target space and the plurality of pieces of property information regarding the plurality of sample spaces; and
outputting the determined recommendation space.

18. The method of claim 11, wherein the acquired space data comprises at least one from among depth information and color information regarding the target space, respectively sensed by a distance sensor and an image sensor.

19. A computer-readable recording medium, having recorded thereon a program for performing the method of claim 11 on a computer.

20. An electronic apparatus comprising:
a processor configured to:
acquire space data regarding a target space, the target space being a habitable space or a non-habitable space in a building,
specify a space of interest in the target space based on a user input, and
determine from among a plurality of tangible objects a recommendation object to be placed in the space of interest based on a size of the space of interest and sizes of the plurality of tangible objects; and
an output interface configured to output the recommendation object.
